(19) United States
(12) Patent Application Publication
(10) Pub. No.: US 2019/0211891 A1
(43) Pub. Date: Jul. 11, 2019

(54) SLEEVE-TYPE FREEWHEEL WITH TORQUE LIMITATION FOR TWO-WHEELED VEHICLE STARTER APPLICATIONS

(71) Applicant: SCHAEFFLER TECHNOLOGIES AG & CO. KG, HERZOGENAURACH (DE)

(72) Inventor: Alexander REIMCHEN, Herzogenaurach (DE)

(73) Assignee: SCHAEFFLER TECHNOLOGIES AG & CO. KG, HERZOGENAURACH (DE)

(21) Appl. No.: 16/330,796

(22) PCT Filed: Sep. 18, 2017
(86) PCT No.: PCT/DE2017/100793

§ 371 Date: Mar. 6, 2019

(30) Foreign Application Priority Data
Sep. 29, 2016 (DE) 10 2016 218 929.8

(51) Int. Cl. F16D 41/067

(52) U.S. Cl. CPC F16D 41/067

(57) ABSTRACT

A clamping freewheel has a ring element, being either an inner ring or an outer ring. The ring element has a plurality of clamping ramps (or ramped surfaces) for clamping a clamping element (or roller). One clamping element is disposed between one of the clamping ramps and the ring element. At least one of the clamping ramps includes a first region and a second region, wherein the second region is configured as a power transmission region and the first region is configured as an overload region. Slipping between the ring element and another ring element is allowed while the clamping element is located and rolling along the first region. No slipping is allowed between the ring element and the other ring element while the clamping element is located and rolling along the second region.

### CROSS-REFERENCE TO RELATED APPLICATIONS

This application is the U.S. National Phase of PCT/DE2017/100793 filed Sep. 18, 2017, which claims priority to DE 102016218929.8 filed Sep. 29, 2016, the entire disclosures of which are incorporated by reference herein.

### TECHNICAL FIELD

The disclosure relates to a clamping freewheel, in particular a clamping freewheel with a ring element, in particular an inner ring or outer ring, that has at least one clamping ramp for clamping a clamping element, and one clamping element for each clamping ramp that bears on the at least one clamping ramp.

### BACKGROUND

A freewheel, or a clamping freewheel, respectively, is a directionally shifted coupling, and normally has an inner ring, an outer ring, and a cage with clamping rollers and springs. The clamping freewheel can disengage a portion of the drive train from a rotational movement if the load ratios change.

Freewheels are typically used as return stops or overrunning clutches.

With a starting freewheel used as an overrunning clutch, springs and clamping rollers or clamping elements are normally used, which are pressed into pockets or onto clamping profiles or clamping ramps of an inner or outer ring. Because the clamping elements are in receiving spaces that are delimited in part by the clamping profiles or the clamping ramps that taper away from the springs, a torque that is transferred from the inner ring to the outer ring increases, for example, as the two rings are rotated in relation to one another.

With an appropriate selection of the angle of incidence, or clamping, of the clamping profile, the freewheel is prevented from slipping, because it is in the so-called self-inhibiting state. The clamping angle is selected such that it is less than or equal to the arc tangent of the slippage friction coefficient μ of the two materials rubbing against one another. If the clamping angle is greater than the arc tangent of μ, the freewheel slips, and cannot transfer forces.

A starting freewheel is used in particular in internal combustion engines for motorcycles with electric starters. A starter pinion equipped with a freewheel is driven by an electric motor to start the internal combustion engine. The starter pinion is normally connected to the inner ring of the freewheel, while the outer ring is normally connected to the alternator.

The freewheel transfers forces to the alternator via the outer ring until the internal combustion engine ignites. As soon as the engine ignites, the crankshaft connected to the alternator is accelerated to a higher rotational rate than that for starting the engine.

The freewheel then disengages the running engine, or its crankshaft, from the electric starter, such that the engine does not damage or destroy the starter with an excessive rotational rate.

A problem of overload forces being introduced in a freewheel is known from the prior art, in which the clamping elements are pressed back and quickly into the clamping profile or against the clamping ramps such that these are deflected, which can result in an immediate total breakdown of the freewheel.

It is therefore an object of the disclosure to produce a freewheel or clamping freewheel, respectively, and a freewheel assembly, which provides effective protection against overload forces introduced into the freewheel, or a rotational rate limit, wherein such a freewheel, or such a freewheel assembly, may ensure a high level of functionality, and can be produced inexpensively and in a material-saving manner.

This object is achieved according to embodiments disclosed below.

### SUMMARY

According to an embodiment, a clamping freewheel, in particular a clamping roller freewheel, comprises a ring element in a first aspect, in particular an inner ring or an outer ring, that has at least one clamping ramp or one clamping profile for clamping a clamping element.

The clamping freewheel may also comprise a clamping element or a clamping roller for each clamping ramp, which bears on the at least one clamping ramp.

The at least one clamping ramp may have at least one first and one second subsection, wherein the second subsection may be configured as a power transfer region, such that a relative movement between the clamping element and the ring element can be suppressed. In this manner, the clamping freewheel can transfer a force or torque from an inner ring to an outer ring, or vice versa. As a result, an internal combustion engine, for example, can be started.

The first subsection may be configured as an overload region, in which a relative movement between the clamping element and the ring element can be obtained. As a result, it is possible to prevent a transfer of force from the first ring element to the at least one clamping element.

In other words, it is beneficial when, if a high torque is quickly or suddenly applied to the clamping freewheel, the clamping elements move from the power transmission region to the overload region. This overload region may prevent damage to the overall freewheel, or clamping freewheel. If overload forces are applied to a freewheel, the clamping elements are quickly pressed backward, into the clamping profile, or against the clamping ramps such that these are pushed out, which in turn can lead to a total breakdown of the freewheel.

Moreover, when the ring element is rotated to transmit forces in the first subsection, the second subsection may follow, such that if there is an overload, the clamping element moves from the second subsection to the first section. As a result, the transmission of force between the first subsection and the at least one clamping ramp, or between the ring element and the clamping element, respectively, can be interrupted. Because of this interruption, the freewheel can be protected against an overload that can damage the freewheel.

The at least one clamping ramp may extend along the circumference. Because the ring elements are normally rotationally symmetrical, they extend radially and axially, wherein the ring elements may have the at least one clamping ramp on their circumference, as well as the associated clamping elements.

The first subsection may be allowed to move between the clamping element and ring element. As a result, no forces or torques can be transferred that can damage the freewheel.

The first subsection may allow for relative movement between the clamping element and the ring element, in that the tangent of the angle between a force that is to be transmitted and a perpendicular to the first subsection at the bearing point between the clamping element and the clamping ramp is greater than or equal to the frictional coefficient of the material of the frictional pair comprising the ring element and clamping element.

Simply put, the first subsection of the clamping ramp may implement the relationship tan α≥μ, via which a clamping between the clamping ramp and the ring element is released, or via which a clamping element slips on the clamping ramp. This in turn results in the freewheel limiting the torque/force applied to the ring element, thus resulting in an overload safeguard.

The second subsection may prevent relative movement between the clamping element and ring element. Forces or torques can be transferred as a result.

The second subsection may prevent relative movement between the clamping element and the ring element, in that the tangent of the angle at the bearing point between the clamping element and clamping ramp, formed between a force that is to be transferred and a perpendicular to the second subsection at the bearing point, is less than the frictional coefficient for the material of the frictional pair comprising the ring element and the clamping element.

In other words, the second subsection of the clamping ramp may implement the relationship tan α<μ, whereby a clamping is obtained between the clamping ramp and the ring element, or whereby a clamping element is clamped to the clamping ramp. As a result, the freewheel transfers the torque/force applied to the ring element.

The angle for the first subsection may be greater than 15°, wherein the angle at the second subsection may be 3° to 4.5°. The angular ranges result in slippage when tan α≥μ, or clamping when tan α<μ. In other words, with an angle of greater than 15°, slippage can be easily obtained between the clamping element and clamping ramp or ring element, while in contrast, with an angle between 3° and 4.5°, the clamping element is clamped to the clamping ramp or ring element.

Moreover, the ring element is thin-walled. This results in material savings, and thus cost savings.

The ring element may be thin-walled, such that the hollow cylindrical ring element has a wall thickness outside a clamping ramp comprising a fraction of the thickness of a clamping element, e.g., less than half the thickness of the clamping element, more particularly less than 0.3 times the thickness of the clamping element. The circumferential wall thickness at the thickest or thinnest part of the first ring element may be a fraction of the thickness of a clamping element. The aforementioned relationship results in a particularly simple and material-saving production possibility.

A second embodiment of the present disclosure comprises a freewheel assembly with a clamping freewheel, a first ring element, in particular in the form of an inner ring or outer ring, that has at least one clamping ramp for clamping a clamping element, and a second ring element, in particular an outer or inner ring, respectively.

It is expressly noted that the features of the clamping freewheel specified under the aspect of the present description can be used individually or in combinations thereof for the freewheel assembly.

In other words, the features specified above under the first embodiment relating to the clamping freewheel, can also be combined with other features herein under the second embodiment.

Advantageously, the first ring element may include a clamping element for each clamping ramp, which bears on the at least one clamping ramp.

The at least one clamping ramp may have at least one first and one second subsection.

The first subsection may be designed as an overload region, such that the clamping element moves in relation to at least one clamping ramp, whereby a transfer of forces from the first ring element via the clamping element to the second ring element can be prevented. As a result, transfer of forces from the first ring element to the second ring element, or in the other direction, can be prevented. In other words, the clamping element can move from the force transferring region to the overload region if a high torque is suddenly or quickly applied to the clamping freewheel. This overload region preferably protects the freewheel, or clamping freewheel, from damage. If excessive forces are applied to a freewheel, the clamping element is pressed backward and quickly into the clamping profile, or against the clamping ramp, such that it would be deflected, which could then result in a total breakdown of the freewheel.

The second subsection may be designed as a force transferring region, such that the at least one clamping ramp and the clamping element clamp together. The clamping ramp and the clamping element may fulfill the condition tan α<μ, whereby it can be ensured that forces are transferred from the first ring element via the clamping element to the second ring element.

The first subsection may be designed as an overload region, such that the at least one clamping ramp and the clamping element can slip. The clamping ramp and clamping element advantageously fulfill the slippage condition tan α≥μ, whereby it is possible to prevent a transfer of force from the first ring element via the clamping element to the second ring element.

The first ring element and the second ring element may be concentric. Such a configuration ensures low mechanical losses and a simple construction, resulting in savings in costs.

The clamping element may bear on the at least one clamping ramp of the first ring element and on a surface of the second ring element. The clamping element thus connects the first and second ring elements to one another directly, such that forces can be transferred from the first ring element to the second, or in the other direction.

The at least one clamping ramp is oriented spatially in the first ring element such that the spacing between the at least one clamping ramp of the first ring element and the surface of the second ring element is increased, e.g. continuously, along the course thereof in the direction of rotation for the first ring element, in which a force can be transferred from the first ring element to the second ring element. Forces can thus be transferred from the first ring element to the second, or in the other direction.

The spacing may relate to a path that runs in the extension through a rotational center of the first and/or second ring elements. The spacing is therefor the shortest distance between the first and second ring elements, or between the clamping ramp and ring element.

The surface of the first subsection of the at least one clamping ramp on the first ring element may form an angle with a tangent at the bearing point between the clamping element and the surface of the second ring element that is greater than 30° when the freewheel assembly is at a standstill.

The surface of the second subsection of the at least one clamping ramp on the first ring element may form an angle with a tangent at the bearing point between the clamping element and the surface of the second ring element that is between 6° and 9° when the freewheel assembly is at a standstill.

The aforementioned angular ranges result in slippage when tan α≥μ, and clamping when tan α<μ. In other words, with an angle of greater than 30°, slippage between the clamping element and the clamping ramp, or between the clamping element and ring element can be obtained, while in contrast, with an angle between 3° and 4.5°, clamping of the clamping element and clamping ramp, or the clamping element and ring element can be ensured.

The first ring element may form an outer ring and the second ring element forms an inner ring.

Alternatively, it is also possible for the first ring element to form an inner ring and the second ring element to form an outer ring.

The concepts of the disclosure given above may be expressed differently below.

These concepts may be based on—in a simplified version—different types of freewheels used as electric starter freewheels for motorcycles. These include clamping element freewheels and roller freewheels.

Most of the freewheels have a torque capacity that is many times greater than the nominal load. The reason for this oversizing is a “worst case” scenario that may result from misfiring, in which a large torque or force is quickly applied to the freewheel.

If the freewheel is not robust enough, or the environment is not stable enough, the starter suffers a total breakdown.

For this reason an object is to equip current freewheel designs with an overload protection—a torque limiting function.

Clamping freewheels are normally constructed with a clamping ramp/ramp/clamping angle α1 of 3° to 4.5°, in order to obtain the greatest degree of starting safety.

The formula tan α<μ may be applied thereby. Perpendicular forces act on the outer ring/housing of the freewheel when clamping, and expand them. The clamping rollers beneficially move along the ramp geometry, or the clamping ramp.

A freewheel according to the disclosure may have a further, significantly steeper ramp section, in which the contact points between the clamping rollers or clamping elements and the outer ring or ring element are displaced when a predetermined torque has been reached, whereby the clamping condition becomes unbalanced. As a result, the clamping elements slip in the further ramp section, limiting the torque that is to be transferred, or the load.

In other words, the clamping ramp in a freewheel may be provided with a second, significantly steeper section at a targeted position. The clamping condition tan α<μ may then no longer be satisfied, and the clamping rollers or clamping elements begin to slip on the clamping ramp or the ring element.

### BRIEF DESCRIPTION OF THE DRAWINGS

The disclosure shall be explained in greater detail below based on exemplary embodiments in conjunction with associated drawings. Therein:

FIG. 1 shows, schematically, a sectional view of a clamping freewheel according to an embodiment, or a freewheel assembly according to an embodiment, respectively;

FIG. 2 shows, schematically, an enlarged sectional view of a clamping element of the clamping freewheel shown in FIG. 1, in a first state;

FIG. 3 shows, schematically, an enlarged sectional view of a clamping element of the clamping freewheel shown in FIG. 1, in a second state;

FIG. 4 shows, schematically, another enlarged sectional view of a clamping element of the clamping freewheel shown in FIG. 1, in a first state; and

FIG. 5 shows, schematically, an enlarged sectional view of the clamping freewheel shown in FIG. 1, without a clamping element.

### DETAILED DESCRIPTION OF THE DRAWINGS

The same reference symbols are used for identical objects in the following description.

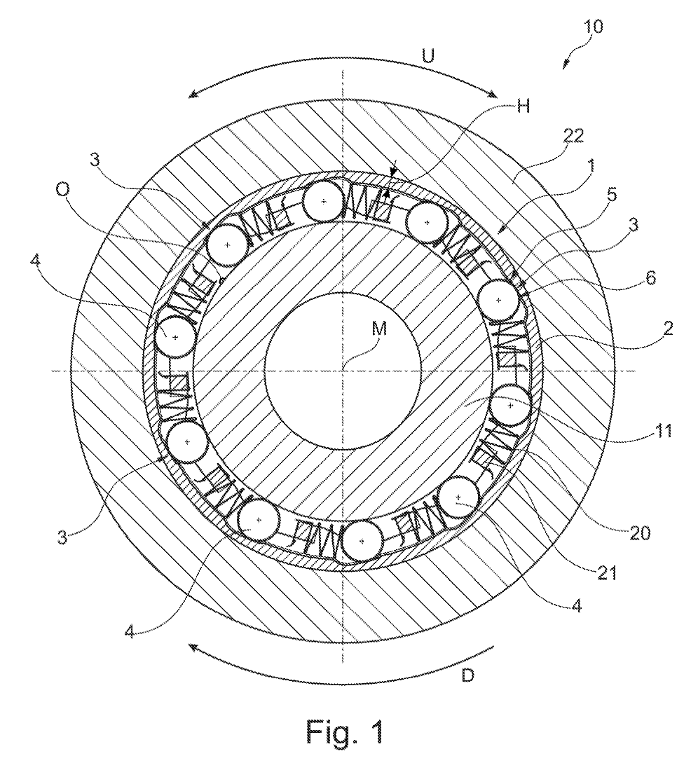

FIG. 1 shows a sectional view of a clamping freewheel 1 according to an embodiment, or a freewheel assembly 10 according to an embodiment.

The freewheel assembly 10 has a clamping freewheel 1 with a first ring element 2 that comprises numerous clamping ramps 3 and numerous clamping elements 4, wherein each clamping ramp 3 clamps a clamping element 4. The first ring element 2 is an outer ring therein.

The first ring element 2 is pressed into an outer ring element 22 for a form fitting and force fitting connection. In this manner, the first ring element 2 can be thin walled and used in various configurations inside an outer ring element 22.

The first ring element 2 is made of sheet metal in order to obtain the thin walled construction.

In the present case, the ring element 2 is thin walled such that the hollow cylindrical ring element 2 has a wall thickness H outside the clamping ramp 3, or at the thickest point of the first ring element 2 along the circumference U, that comprises a fraction of the thickness of a clamping element 4.

According to the exemplary embodiment in FIG. 1, the wall thickness H is less than 0.3 times the thickness of a clamping element 4.

Furthermore, the freewheel assembly 10 comprises a second ring element 11, which in the present exemplary embodiment is an inner ring.

The first ring element 2, or the outer ring, has one clamping element 4 for each clamping ramp—as indicated above—wherein the clamping element 4 bears on the respective clamping ramp 3, or the clamping element 4 is in contact with the clamping ramp 3, respectively.

Moreover, each of the clamping elements 4 shown therein bears on the associated clamping ramp 3 of the first ring element 2 and on a surface O of the second ring element 11. In this manner, a force can be transferred from the first ring element 2 to the second ring element 11 via the clamping element, or vice versa.

Each clamping ramp 3 has at least a first subsection 5 and a second subsection 6.

When the clamping freewheel 1 or the freewheel assembly 10 is in operation, the first ring element, rotating in the direction of rotation D, transfers a force to the second ring element 11 via the clamping elements 4.

The clamping elements 4 move along the tapered ramp geometry of the clamping ramps 3 when the first ring element 2 moves in the rotational direction D.

The clamping elements are clamped between the clamping ramp 3, or the first ring element 2, and the second ring element 11 inside the second clamping region 6 of the clamping ramp 3.

If, however, a large force or torque is applied to the clamping freewheel 1 in a short time interval, the clamping elements 4 move from the second subsection 6 of the clamping ramp 3 to the first subsection 5.

This second subsection prevents the overall clamping freewheel 1, or the overall clamping freewheel assembly 10, from becoming damaged. This is because if excessive forces are applied to a freewheel, the clamping elements 4 are pressed back quickly into the clamping profile, or against the clamping ramp 3, such that it becomes damaged, which in turn can lead to a total breakdown of the freewheel.

Consequently, the first subsection 5 in the exemplary embodiment in FIG. 1 forms an overload region, such that each clamping element 4 moves in relation to the respective clamping ramp 3, via which a transfer of force from the first ring element 2 to the second ring element 11 via the clamping element 4 can be prevented.

In other words, the first subsection 5 forms an overload region, such that a clamping element 4 slips on the respective clamping ramp 3.

Specifically, the first subsections 5 of each clamping ramp 3 and an associated clamping element 4 fulfill the slippage condition tan α≥μ, via which a transfer of force from the first ring element 2 to the second ring element 11 via the clamping element 4 can be suppressed, or is prevented.

In contrast, the second subsection 6 is a force transfer region, designed such that a clamping element 4 clamps to the respective clamping ramp 3. The second subsection 6 of each clamping ramp 3 and an associated clamping element 4 fulfill the clamping condition tan α<μ thereby, via which a transfer of force from the first ring element 2 to the second ring element 11 via the clamping element 4 can be ensured, or can take place.

Moreover, FIG. 1 shows that the first ring element 2 and the second ring element 11 are concentric to one another and to the center/rotational center M of the freewheel assembly 10.

The outer ring element in the present exemplary embodiment shown in FIG. 1 serves together with the first ring element 2 as a drive, and the second ring element 11 functions as a drive output.

As specified above, the drive direction, or the rotational direction D for transferring forces from the first ring element 2, or the outer ring element 22, to the second ring element 11, is indicated in FIG. 1.

The freewheel assembly 10 according to FIG. 1 can only transfer forces from the drive, or the first ring element 2, to the drive output, or the second ring element 11, when the first ring element 2 is rotating at a rate that is greater than or equal to the rotational rate of the second ring element 11. Both ring elements 2, 11 must be rotating in the same direction D for this.

In addition to the clamping elements 4, one spring element 20 for each clamping element 4 is shown between the first ring element 2 and the second ring element. The spring elements 20 are compression springs that press against the associated clamping element 4 counter to the direction of rotation D.

While a clamping element 4 bears on one end of a spring element 20, the spring element 20 bears on a web 21 at the other end. This web 21 is connected to the first ring element 2.

Each clamping ramp 3 is oriented spatially in the first ring element 2 such that it enlarges the spacing X between the clamping ramp 3 of the first ring element 2 and the surface O of the second ring element 11 along its course in the rotational direction D of the first ring element 2. The enlargement is continuous, at least in the second subsection 6 of the clamping ramp 3.

It should be noted with regard to FIG. 1 that in addition to the rotational direction D, the circumferential direction U is also indicated therein.

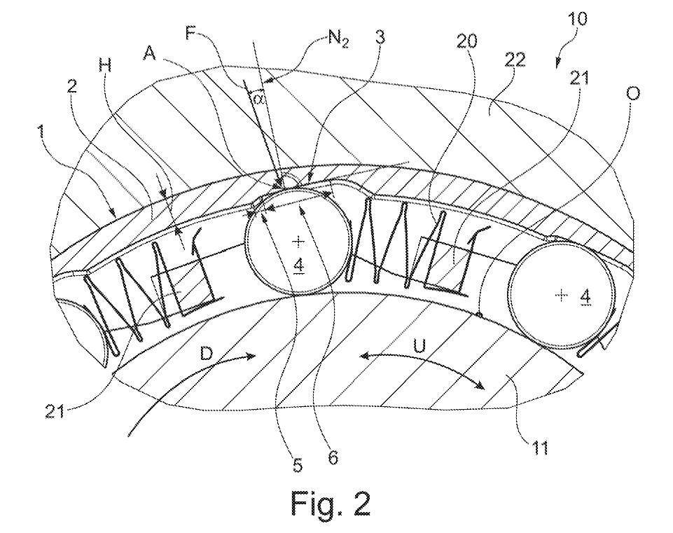

FIG. 2 shows an enlarged sectional view of a clamping element 4 of the clamping freewheel 1 according to the embodiment shown in FIG. 1 in a first state.

Therein, the ring element 2 is an outer ring in the clamping freewheel 1, or the clamping roller freewheel 1, that has various clamping ramps 3, each of which clamps the clamping elements 4.

The clamping freewheel 1 also comprises—as explained above—one clamping element 4 for each clamping ramp 3, bearing on the respective clamping ramp 3.

Each clamping ramp 3 has at least one first subsection 5 and one second subsection 6, and extends in the circumferential direction U.

The first subsection 6 forms a force transferring region, such that a relative movement between the clamping element 4 and the ring element 2 can be prevented.

The first subsection 5 forms an overload region that allows for relative movement between the clamping element and ring element 2, by means of which a transfer of force from the first ring element 2 to the at least one clamping element 4 can be prevented.

When the ring element 2 is rotated for transferring force, or when the ring element 2 rotates in the rotational direction D, the first subsection 5 follows the second subsection 6. As a result, if there is an overload, the clamping element 4 moves from the second subsection 6 to the first subsection 5 in order to interrupt the transfer of force between the first subsection 5, each clamping ramp 3, and the respective associated clamping elements 4.

In the state shown in FIG. 2, the clamping elements 4 are located in the second subsection 6 of the clamping ramp 3.

In this state, the second subsection 6 prevents relative movement between each clamping element 4 and ring element 2.

This is obtained in that the tangent of the angle α at the bearing point between the clamping element 4 and the clamping ramp 3, which is formed between a force F that is to be transferred and a perpendicular N2 to the second subsection 6 at the bearing point A, is less than the frictional coefficient μ for the material of the frictional pair formed by the ring element 2 and the clamping element 4.

The angle α is between 3° and 4.5° in the second subsection 6. The perpendicular N2 is perpendicular to the plane of the second subsection 6 of the clamping ramp 3.

Simply put, this means that each clamping ramp 3 and each associated clamping element 4 are clamped, or clamped to one another, such that the clamping condition tan α<μ is satisfied. As a result, forces can be transferred from the first ring element 2 to the second ring element 11 via the clamping element 4.

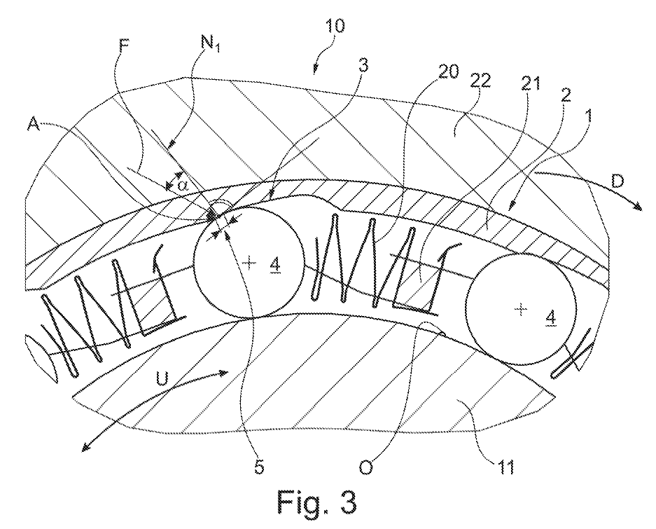

FIG. 3 shows that the clamping elements 4 are located, or placed, in the first subsection 5 of the clamping ramp.

In the state shown in FIG. 3, the first subsection 5 allows relative movement between the clamping elements 4 and the ring element 2.

This is obtained in that the tangent of the angle α at the bearing point A between each clamping element 4 and each clamping ramp 3, which is formed between a force F that is to be transferred and a perpendicular N1 to the first subsection 5 at the bearing point A, is greater than or equal to the frictional coefficient μ for the materials of the frictional pair formed by the ring element 2 and the clamping element 4.

The angle α is greater than 15° for the first subsection 5. The perpendicular N1 is perpendicular to the plane of the first subsection 5 of the clamping ramp 3.

Simply put, in reference to FIG. 3 this means that the first subsection 5 forms an overload region, such that each clamping ramp 3 and each associated clamping element 4 slip, or slip in relation to one another, or do not clamp, respectively. In this manner, the slippage condition tan α≥μ is satisfied. As a result, transfer of forces from the first ring element 2 to the second ring element 11 via the clamping element 4 can be prevented.

It should also be noted that in a comparison of FIGS. 2 and 3, the spring elements 2 for each clamping element 4 push counter to the direction of rotation D. Each spring element 20 bears on a clamping element 4, or each clamping element 4, in FIG. 2, while in FIG. 3, the clamping elements 4 and spring elements 20 are not in contact with one another.

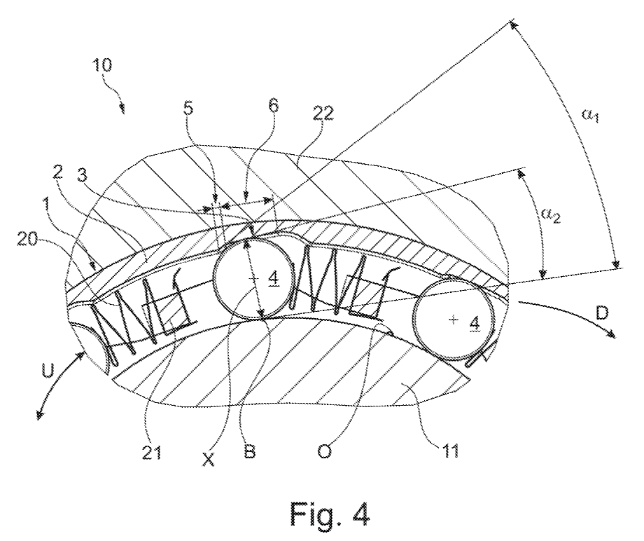

FIG. 4 is substantially identical to FIG. 2, but with additional reference symbols. FIG. 4 also shows the freewheel assembly 10, or clamping freewheel 1, at a standstill, or in a state in which no forces are transferred.

When stationary, the surface of the first subsection 5 forms an angle α1 with each clamping ramp 3 of the first ring element 2 with a tangent at the bearing point B between the clamping element 4 and the surface O of the second ring element. This angle α1 is greater than 30°.

Furthermore, when the freewheel assembly 10 is at a standstill, the surface of the second subsection 6 in each clamping ramp 3 of the first ring element 2 forms an angle α2 with a tangent at the bearing point B between the clamping element 4 and the surface O of the second ring element 11. This angle is between 6° and 9°.

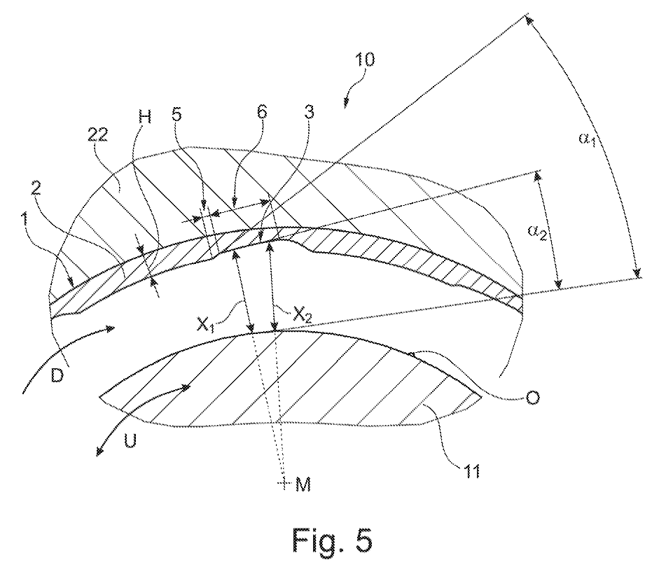

FIG. 5 shows an enlarged sectional view of the clamping freewheel 1 according to the embodiment in FIG. 1, without the clamping elements 4.

Firstly, angles α1 and α2 are again indicated therein, as described above in reference to FIG. 4.

Moreover, it can be clearly seen in FIG. 5 that each clamping ramp 3 is oriented spatially in the first ring element 2 such that it enlarges the spacing X between each clamping ramp 3 of the first ring element 2 and the surface O of the second ring element along its course in the rotational direction D of the first ring element 2, in which a force can be transferred from the first ring element 2 to the second ring element 11.

Thus, spacing X2 is greater than spacing X1, as shown in FIG. 5.

These spacings X1 and X2 are distances that extend through the rotational center, or center M, of the ring element 2. In this manner, the spacings indicate the shortest distance between the first ring element 2 and the second ring element 11, or between the clamping ramp 3 and the surface O of the ring element 11.

In the present example according to FIG. 5, the spacing between the first ring element 2 and the surface O of the second ring element 11 increases in the rotational direction D and in the region of a clamping ramp 3 in a continuous manner.

### LIST OF REFERENCE SYMBOLS

1 clamping freewheel
2 first ring element
3 clamping ramp
4 clamping element
5 first subsection
6 second subsection
10 freewheel assembly
11 second ring element
20 spring element
21 web
22 outer ring element
A rotational axis
D rotational direction
F force
M center
N1 perpendicular
N2 perpendicular
O surface
U circumferential direction

1. A clamping freewheel comprising:
a ring element being either an inner ring or an outer ring, the ring element having at least one clamping ramp;
at least one clamping element, each clamping element bears on and rolls along a respective one of the at least one clamping ramps;
wherein each of the at least one clamping ramps has at least one first subsection and one second subsection,
wherein the second subsection is a force transfer region, such that a relative movement between the at least one clamping element and the ring element can be prevented,
wherein the first subsection is an overload region, such that relative movement between clamping elements and the ring element is allowed via which a transfer of force from the ring element to the at least one clamping element can be prevented.

2. The clamping freewheel according to claim 1,
wherein the first subsection allows for relative movement between clamping elements and the ring element in that a tangent of an angle (α) at a bearing point (A) between the at least one clamping element and the at least one clamping ramp, formed between a force (F) that is to be transferred perpendicular (N1) to the first subsection at the bearing point (A), is greater than or equal to a frictional coefficient (μ) for materials force by the ring element and the clamping element, and
wherein the second subsection prevents relative movement between the clamping elements and the ring element in that the tangent of a second angle (α) at the bearing point (A) between a clamping element and the clamping ramp, formed between a second force (F) that is to be transferred perpendicular (N2) to the second subsection at the bearing point (A), is less than the frictional coefficient (μ) for the materials of the frictional pair formed by the ring element and the clamping element.

3. The clamping freewheel according to claim 2,
wherein the first angle (α) for the first subsection is greater than 15°,
wherein the second angle (α) in the second subsection is between 3° to 4.5°.

4. The clamping freewheel according to claim 1,
wherein the ring element is made of sheet metal, and
wherein the ring element is thin walled such that the ring element has a wall thickness outside the at least one clamping ramp that is less than half of the thickness of the at least one clamping element.

5.-9. (canceled)

10. A clamping freewheel assembly for selectively transferring torque therethrough, the clamping freewheel assembly comprising:
an inner ring;
an outer ring disposed about the inner ring and having an inner surface that defines a plurality of ramped surfaces; and
a plurality of rollers, each roller configured to roll along a respective one of the ramped surfaces;
wherein each of the plurality of ramped surfaces includes a first section ramped at a first pitch, and an adjacent second section ramped at a second pitch different than the first pitch;
wherein a first torque of a first magnitude urges the rollers to clamp between the second section of the ramped surfaces and the inner ring, and a second torque of a second magnitude larger than the first magnitude urges the rollers to clamp between the first section of the ramped surface and the inner ring.

11. The clamping freewheel assembly of claim 10, wherein relative rotation between the inner ring and the outer ring is enabled while the rollers are contacting the first section of the ramped surfaces.

12. The clamping freewheel assembly of claim 11, wherein a tangent of an angle (α) at a bearing point (A) between the rollers and the ramped surfaces, formed between a force (F) that is to be transferred perpendicular (N1) to a first subsection at the bearing point (A), is greater than or equal to a frictional coefficient (μ) for materials of the inner ring and the rollers.

13. The clamping freewheel assembly of claim 12, wherein the angle is greater than 15 degrees.

14. The clamping freewheel assembly of claim 12, wherein relative rotation between the inner ring and the outer ring is prevented when the second torque forces the rollers to contact the second section of the ramped surfaces.

15. The clamping freewheel assembly of claim 14, wherein a tangent of an angle (α) at the bearing point (A) between the rollers and the ramped surfaces, formed between a force (F) that is to be transferred perpendicular (N2) to the second subsection at the bearing point (A), is less than a frictional coefficient (μ) for the materials of the frictional pair formed by the inner ring and the rollers.

16. The clamping freewheel assembly of claim 15, wherein the angle is between 3 and 4.5 degrees.

17. The clamping freewheel assembly of claim 10, wherein the first sections of the ramped surfaces includes a linear sections.

18. The clamping freewheel assembly of claim 10, wherein the second sections of the ramped surfaces includes linear sections.
